(19) United States
(12) Patent Application Publication
(10) Pub. No.: US 2022/0295135 A1
(43) Pub. Date: Sep. 15, 2022

(54) Video providing system and program

(71) Applicant: Takuya KIMATA, Kanagawa (JP)

(72) Inventor: Takuya KIMATA, Kanagawa (JP)

(21) Appl. No.: 17/753,571

(22) PCT Filed: Dec. 25, 2019
(86) PCT No.: PCT/JP2019/050933

§ 371 Date: Mar. 8, 2022

(30) Foreign Application Priority Data
Sep. 11, 2019 (JP) 2019-165370

(51) Int. Cl. H04N 21/41; H04N 21/475; H04N 21/4788; H04N 21/8545

(52) U.S. Cl. CPC H04N 21/4126; H04N 21/4758; H04N 21/4788; H04N 21/8545

(57) ABSTRACT

An object of the present invention is to provide a video providing system and a program that allow a viewer to actively edit digital content. A video providing system 100 that provides video content to a viewer includes: a component 104, 105, 106 for receiving a guidance trigger prompting the viewer to participate in the video content at a device of the viewer; a component 103, 1602, 1603 for accepting an option content command or option content that is different from mainstream content corresponding to a viewer trigger sent from the device as a response to the guidance trigger through a network; and a component 101, 102, 1605 for reproducing or displaying the option content on a display device specified by the command.

### TECHNICAL FIELD

The present invention relates to a technique for allowing viewers to participate in digital content, and more particularly relates to an on-demand video providing system and program for providing different digital content in accordance with behavior of viewers.

### BACKGROUND

With the progress of information processing technology and computer hardware technology, movies screened by movie theaters, cinema complexes, and the like are also increasingly provided as digital contents and screened through projectors and the like. In addition to the movie theaters, the cinema complexes, and the like, recently, services that provide contents such as movies to users of personal computers by streaming the contents to personal computers have also been possible.

In such video processing environments, conventional movies are provided as a single continuous content up to the end of a story with a director letting a performer act along a prescribed story and shooting performance of the performer. By the way, in recent years, when movies and the like are provided as digital contents, more dynamic video provision is possible compared to analog video provision. As such video provision, JP-A 2011-124972 (Patent Document 1), for example, describes a system in which, when digital content is provided via a network, data indicating user preference is received from a terminal of the user to provide a content stream that differs for each user.

Further, JP-A 2010-088111 (Patent Document 2) describes a stream providing method for providing different video for each viewer. Although technology described in Patent Document 2 enables different videos to be provided for each viewer, different videos are provided to viewers by a function such as a shutter and the like and does not change content streaming or context.

As described in Japanese Patent No. 5,581,437 (Patent Document 3) and Japanese Patent No. 6,324,829 (Patent Document 4), the present inventor proposed a video providing system for sharing contents among many viewers.

Patent Document 3 and Patent Document 4 change digital content in a viewer participating type in content that is viewed by many viewers in a theater or the like, and enable real-time content modification in theaters, projection mapping or the like. However, the techniques described in Japanese Patent No. 5,581,437 and Japanese Patent No. 6,324,829 do not describe a configuration that enables content editing involving viewers in a content providing form such as DVD/Blue-Ray/video streaming.

### PRIOR ART DOCUMENT

### Patent Document

Patent Document 1: JP-A 2011-124972

Patent Document 2: JP-A 2010-088111

Patent Document 3 is Japanese Patent No. 5,581,437

Patent Document 4 is Japanese Patent No. 6,324,829

### SUMMARY OF THE INVENTION

### Problem to be Solved by the Invention

An object of the present invention is to provide a video providing system and program capable of editing progress of digital content provided as theater, live performance, and DVD/Blue-Ray/video streaming in a manner involving viewers.

### Means for Solving the Problem

That is, according to the present invention, there is provided a video providing system for providing digital content to a viewer, the system comprising: a component for receiving a guidance trigger prompting the viewer to participate in video content at a device of the viewer; a component for accepting an option content command or option content that is different from mainstream content corresponding to a viewer trigger sent from the device as a response to the guidance trigger through a network; and a component for reproducing or displaying the option content on a display device.

The guidance trigger is provided to the device through a function of the device including voice, vibration, email and SNS.

Reproduction of the option content is performed through a media medium and displaying the option content displays the option content acquired through the network on the display device, a video screen, or an object.

Reproduction of the option content is performed by video streaming.

Display of the option content is performed by the video screen or projection mapping.

The video providing system comprises a collaboration server for communicating between a plurality of viewers.

The collaboration server performs collaboration by voice communication using SNS.

The collaboration server determines the option content by voting of a large number of the viewers.

Further, according to the present invention, there is provided a program for providing the above functions.

### BRIEF DESCRIPTION OF THE DRAWINGS

FIG. 1 is a diagram showing an embodiment of a video providing system 100 of the present embodiment.

FIG. 2 is a diagram showing a functional block of a collaboration server 120 of the present embodiment.

FIG. 3 is a diagram showing a functional block of a content reproducing device 103 of the present embodiment.

FIG. 4 is a diagram showing a functional block of a streaming server 130 of the present embodiment.

FIG. 5 is a diagram showing an embodiment of video content 500 provided by the video providing system 100 of the present embodiment.

FIG. 5 is a diagram showing an embodiment of viewer information associated with viewers, viewer identification information, and access information from viewers in the present embodiment.

FIG. 7 is a diagram showing an embodiment of linking option content to mainstream content when digital content is reproduced from a media medium such as a DVD or Blue-Ray in the present embodiment.

FIG. 8 illustrates an arrangement of a guidance trigger when streaming video content in the present embodiment.

FIG. 9 is a flowchart of processing performed by the video providing system 100 of the present embodiment.

FIG. 10 is a diagram showing a data configuration of scenes 100 used in the present embodiment.

FIG. 11 is a diagram showing a stream of digital content to be edited by the present embodiment.

FIG. 12 is a diagram showing a stream of digital content to be edited by the present embodiment.

FIG. 13 is a diagram showing a stream of digital content to be edited by the present embodiment.

FIG. 14 is a diagram showing an embodiment of the guidance trigger that can be used in the present embodiment.

FIG. 15 is a diagram showing a hardware configuration of the content reproducing device 103 of the present embodiment.

FIG. 16 is a diagram showing an embodiment of the video providing system 1600 of the first embodiment of the second embodiment.

FIG. 17 is a diagram showing a functional block of a collaboration server 1606 of the second embodiment.

FIG. 18 is a diagram showing a functional block of a content server 1605 of the second embodiment.

FIG. 19 is a diagram showing an embodiment of a user database created by a viewer manager 1703 described with reference to FIG. 17.

FIG. 20 is a diagram showing an embodiment of a trigger registration form and information used as a scene to be decoded in a mainstream content 2000 of the second embodiment.

FIG. 21 is a flowchart of processing performed by the video providing system 100 of the second embodiment.

FIG. 22 is a diagram showing a data configuration of a scene used in the second embodiment.

FIG. 23 is a diagram showing an embodiment of video content 2300 provided by the video providing system 1600 of the second embodiment.

### EXPLANATION OF REFERENCE NUMERAL

100: video providing system

101: display device

102: speaker

103: content reproducing device

104: smart speaker

105: tablet terminal

106: smartphone

110: network

120: collaboration server

130: streaming server

### MODE FOR CARRYING OUT THE INVENTION

### First Embodiment

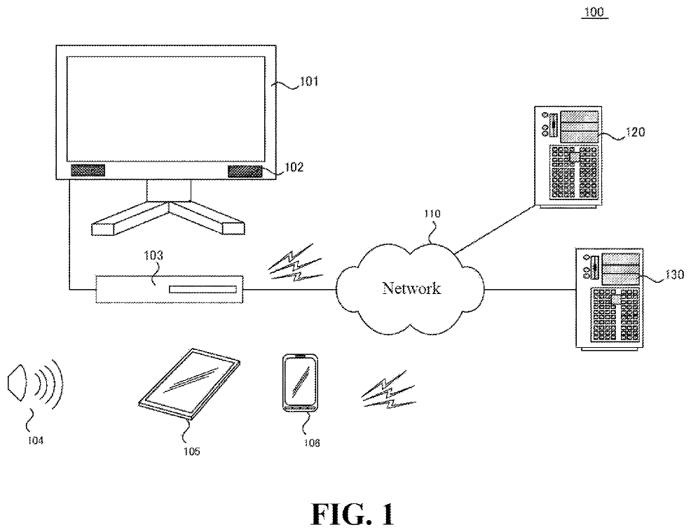

The present invention will be described below with reference to embodiments, but the present invention is not limited to the embodiments described below. FIG. 1 shows an embodiment of a video providing system 100 of the present embodiment. The video providing system 100 shown in FIG. 1 can be installed, for example, in a display device, a home theater, or the like installed at home to provide a realistic sensation for content. The video providing system 100 sends a video stream decoded by a content reproducing device 103 to a display device 101, and the display device 101 displays a video, and at the same time, an audio data accompanying the content is reproduced from the speaker 102.

The content reproducing device 103 is not particularly limited as long as it can be connected to a network 110 and can send video signals and audio signals to the display device 101 and the speakers 102. For example, an information processing device such as a DVD player, a Blu-Ray (registered trademark) player, XBOX (registered trademark) player, PlayStation (registered trademark), or the like, or a personal computer can be used as the content reproducing device 103. Note that the content reproducing device 103 preferably implements a program (which may be an application or firmware) capable of interpreting information sent from the network 110 and editing a reproduction sequence of the content.

Further, a streaming server 130 and a collaboration server 120 are connected to the video providing system 100 through the network 110. The streaming server 130 streams digital content and sends it to the content reproducing device 103 and provides the video via the display device 101 and the speaker 102. Further, the collaboration server 120 provides a function of receiving a user action sent from a smart speaker 104, a tablet terminal 105, or a smartphone 106 accessible by the user, determining the content of the user action, and enabling editing of content to be reproduced later. Note that the device used by the viewer also includes a controller such as Amazon Fire Stick (registered trademark), for example. The display device 101 also includes a projector.

Note that the network 110 is described below as including any one or both of a voice call and data communication using a public telephone network, in addition to communication using a wired or wireless TCP/IP protocol including Gigabit Ethernet, 4G, and 5G. Further, the smart speaker 104, the tablet terminal 105, and the smart phone 106 may be capable of making a voice call using a public telephone line in addition to a voice call via an Internet by a so-called SNS or the like such as Facetime (registered tradename), LINE (registered tradename), Facebook (registered tradename) and Twitter (registered tradename).

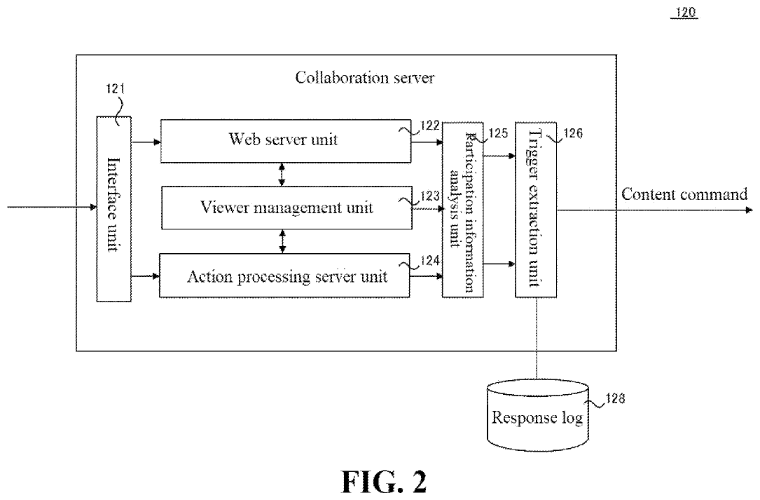

FIG. 2 is a diagram showing a functional block of the collaboration server 120 of the present embodiment. As shown in FIG. 2, the collaboration server 120 is configured to include an interface unit 121, a web server unit 122, and an action processing server unit 124. The web server unit 122 has a function of receiving user information sent by the viewer through the network 110 via the HTTP protocol or a viewer participation information sent through a dedicated application (hereinafter, simply referred to as a smartphone application) that functions on the smart speaker 104, the tablet terminal 105, the smartphone 106, or the like and registering user information, a terminal form used, participation mode, the action, and other information in a viewer management unit 123.

Note that a smartphone or a dedicated portable control device can be used as the device in the present embodiment. When the device is the smartphone, the smartphone functions as a component for receiving a guidance trigger prompting the viewer to participate in video content on viewer's device, a component for accepting an option content command or option content that is different from mainstream content corresponding to a viewer trigger sent from the device as a response to the guidance trigger through a network and a component for reproducing or displaying the option content on a display device as the smartphone application in the present embodiment. It is also conceivable that a dedicated control device such as an PSP downloads or installs a program for the dedicated control device to provide the same function.

The viewer participation information includes the viewer trigger that the viewer can configure as keywords, commands, or the like for modifying the content, and in the case of a voice call, the viewer participation information includes voice call information of the viewer. In addition, operations such as tapping and shaking on a touch screen and the like may also be used as the viewer trigger.

The action processing server unit 124 includes a so-called IVR function, a voice analysis function, and an action analysis function. When the viewer participation information is voice information, the action processing server unit 124 sends the voice information to a participation information analysis unit 125 as the participation information. Further, in a specific embodiment, the voice information of a received voice call may be sent to collaboration server 120 as it is and generated from speaker 104 and may be superimposed on voice information of the decoded digital content so that the viewer present in the space feeds back the voice call as if a participant who sent the voice call was in the content from the beginning. Furthermore, the action processing server unit 124 detects position information, acceleration information, tapping, swiping, and the like transmitted from the tablet terminal 105 and the smartphone 106, and enables editing of the content based on the detected viewer trigger. Note that voice processing function can be configured as a cloud server, and a service including, for example, AI such as Google Assistant (trademark) and IBM Speech to Text (registered trademark) can be used as the cloud service for performing such voice processing but is not limited to a specific cloud service.

A viewer management unit 123 has a function to collect information such as a user ID of the viewer and, as necessary, a password, a terminal form, and a participation mode sent through the network 110 in advance and register the information in a user database (not illustrated). In addition, the web server unit 122 and the action processing server unit 124 each have a function of causing the participation information analysis unit 125 to perform processing corresponding to the participation mode of the viewer when receiving the participation information.

Further, the collaboration server 120 includes the participation information analysis unit 125 that analyzes the viewer participation information sent from the viewer and a trigger extraction unit 126. The participation information analysis unit 125 determines whether the participation information transmitted from the viewer is voice information or a command from the application or the like, decodes the participation information of the viewer in accordance with the participation form of the viewer, and determines whether or not the viewer participation information including a preset viewer trigger is included in the trigger extraction unit 126.

When the viewer trigger is not included, the collaboration server 120 does not issue any particular command to modify the content. Further, in a case where the collaboration server 120 determines that the viewer participation information includes the preset viewer trigger, the collaboration server 120 sends a content command including the viewer trigger to the content reproducing device 103 or the streaming server 130 through the network 110. The command is sent to the content reproducing device 103 or the streaming server 130, and the decoding order and the streaming order of the digital contents decoded by the content reproducing device 103 are switched to enable the viewer to participate in the video and audio.

Further, the collaboration server 120 manages a response log database 128. The response log database 128 registers history of viewer participation in not only the screening of that time, but also the same video or event that was performed in the past by associating the history of viewer participation with the user information, a user attribute, viewing time, viewing area, and the like. Examples of the state of viewer participation include scene selection, action information type, command type from the smartphone application, and the like, and the collaboration server 120 accumulates these as a response log.

In aspects of the present invention, the collaboration server 120 may analyze the response log and learn the content such as scenes and videos that many participants sympathize with in the digital content to provide effective content creation. Further, response information accumulated in the response log database 128 may be used as big data for subsequent content creation.

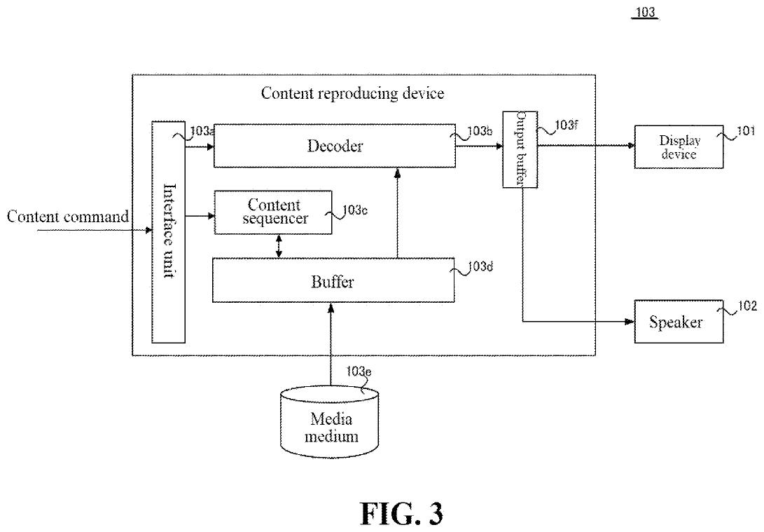

FIG. 3 shows a functional block of the content reproducing device 103 of the present embodiment. A content command is sent from the collaboration server 120 to the content reproducing device 103. The content reproducing device 103 includes an interface unit 103a for processing these signals, a decoder 103b, a content sequencer 103c, a buffer 103d and a media medium 103e.

Hereinafter, the function will be described from the processing unit on the upstream side that has received the participation information from the viewer. The interface unit 103a receives the content command sent from the collaboration server 120 corresponding to an action added to the scene. The interface unit 103a sends the received content command to the content sequencer 103c. The content sequencer 103c analyzes the content command to select a scene ID associated with the viewer trigger included in the content command and causes the scene ID designated for the content reproducing device 103 to be loaded from the media medium 103e into the buffer 103d. Note that the scene means a time-series video provided with a certain meaning or attribute in the mainstream content, which is composed of a plurality of scenes, a plurality of GOPs (Group of Picture), and the like.

The content reproducing device 103 sends the buffered data of the scene ID to the decoder 103b, outputs video information of the scene ID associated with the viewer trigger to an output buffer 103f as the decoding is completed, and sequentially enables reproducing of the selected scene on the display device 101 and the speaker 102. By using the processes described above, the scene of the mainstream content can be reproduced in real time without interruption.

Note that the association between the viewer trigger and the scene ID can be performed by assigning the scene ID to the content corresponding to the viewer trigger, for example, in response to specific keywords such as “go up”, “go down”, “go right”, “go left”, “go forward”, “return”, and the like. In addition, the scene ID to be selected in accordance with an operation such as the position information, the acceleration information, tapping, swiping, or the like of the tablet terminal 105 and the smartphone 106 can be associated, and the viewer trigger and the content associated with the viewer trigger are not particularly limited as long as the realistic sensation of participation in the digital content can be improved.

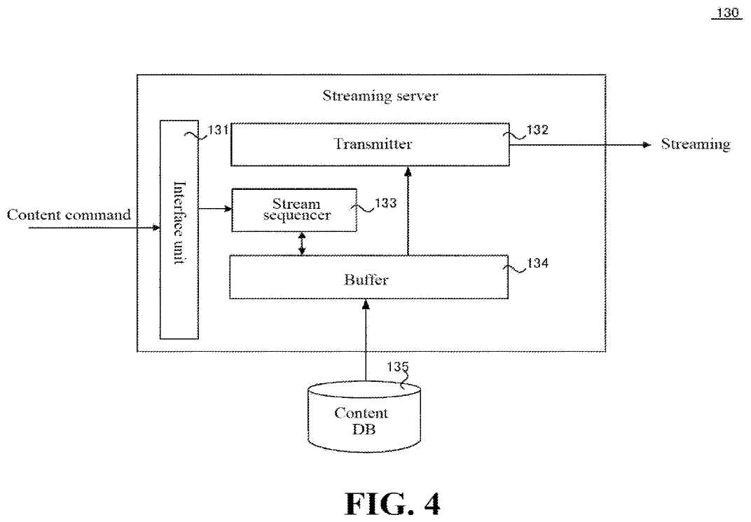

FIG. 4 shows a functional block of the streaming server 130 in the present embodiment. The streaming server 130 includes a configuration similar to that of the streaming server used in, for example, YouTube (registered trademark), NICO Douga (registered trademark), iTunes (registered trademark) and others. However, the streaming server 130 shown in FIG. 4 is different from the conventional streaming server in that it implements functions of the stream sequencer 133. Hereinafter, the functions of the streaming server 130 will be described.

Here, it is assumed that the streaming server 130 is already streaming a specific digital content in response to a request from the viewer. Streaming server 130 receives content designation from collaboration server 120 along with the viewer trigger during streaming of the digital content. When an interface unit 131 that has received the content command determines that the received information includes the content command, the interface unit 131 sends the content command to the stream sequencer 133. The stream sequencer 133 analyzes the viewer trigger included in the content command, selects the scene ID associated with the viewer trigger, and buffers the digital content specified by the scene ID in a buffer 134.

The streaming server 130 sends the buffered digital content to a transmitter 132 as a video stream to be delivered next and sends the content reproducing device 103 through the network 110. Note that, when streaming from the streaming server 130 is performed, the content reproducing device 103 directly provides the stream from the interface unit 103a to the decoder 103b to decode the stream, and then displays a video image on the display device 101 through the output buffer 103f. Note that the content reproducing device 103 can include a plurality of decoders according to types and attributes of the content to be reproduced. Note that examples of preferable encoding methods for streaming purposes include MP2, MP3, MP4, H264, MOV, and the like, and are not particularly limited to a specific format.

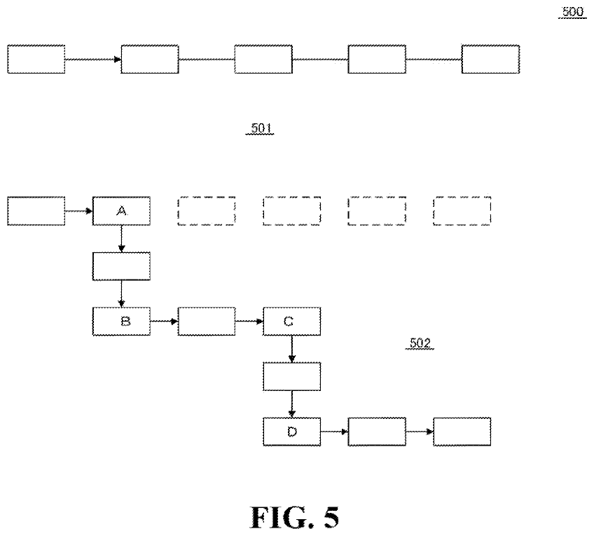

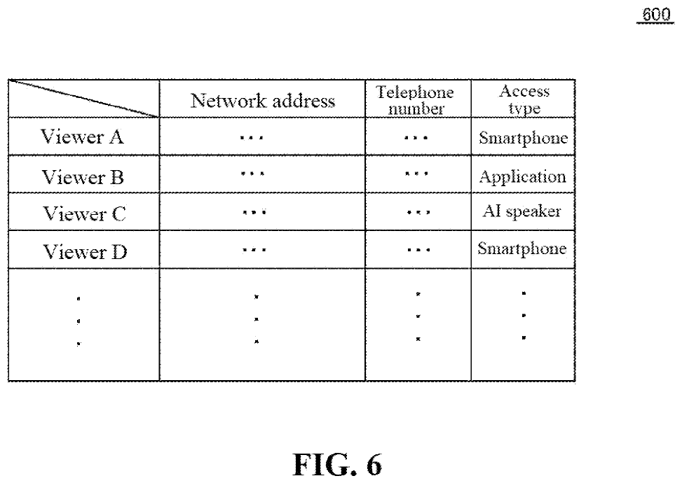

FIG. 5 shows an embodiment of video content 500 provided by the video providing system 100 of the present embodiment. Video content 501 is the mainstream content.

Further, video content 502 is an embodiment in which the sequence of the mainstream content 500 is edited by the participation of the viewer. When the video providing system 100 receives the viewer participation information at a scene A, the content server 120 analyzes the viewer trigger and selects the digital content of scene ID associated with the viewer trigger as the option content for reproducing as the next scene. Therefore, the initially prepared mainstream content 501 is edited in accordance with actions of the viewer.

Then, when another viewer trigger is received in a scene B, the next option content is selected in response to the viewer trigger to provide a video. Here, the option content means the digital content that is replaced with a mainstream scene in response to the viewer trigger. Here, a scene C further receives other viewer triggers to modify the scene sequence, and a scene D also modifies the scene sequence in response to the viewer triggers to continue this until the end of the video.

Note that the viewer who can send the viewer triggers between the scene A-D may be the same or different from each other. Note that if no viewer trigger is received at all, the mainstream content 501 is provided after inserting the option content to provide a reaction such as the phone not being connected.

FIG. 6 shows an embodiment of the viewer information associated with the viewers, viewer identification information and access information from viewers in the present embodiment. The viewers are identified by a network address, a viewer ID, a phone number, and the like, and a device to access each viewer is specified. Note that embodiments may also be envisioned in which a specific viewer accesses from multiple devices.

The collaboration server 120 analyzes the viewer triggers included in the viewer participation information using the information shown in FIG. 6 to enable dynamic editing of content.

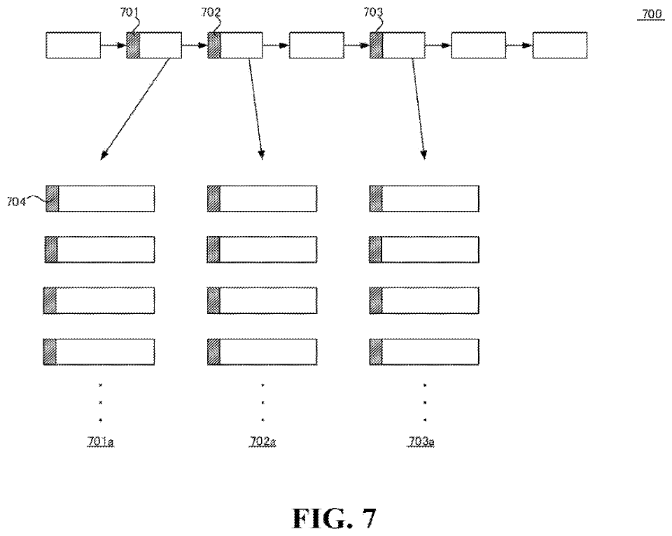

FIG. 7 shows an embodiment of associating the option content with the mainstream content when the digital content is reproduced from the media medium such as DVD or Blu-Ray in the present embodiment. For example, in a specific scene 701 of the mainstream content 700, the guidance trigger is arranged at a head thereof The guidance trigger is information for the digital content to actively prompt the viewer to take an action by voice or the like to the viewer's device.

For example, a phone call from an actor, a question on the screen from the actor, a message transmission, a SNS transmission, a vibration, or the like can be used as the guidance trigger, and a plurality of option content 701a associated with each of the guidance triggers are recorded in association with the scene ID. For example, when the guidance trigger sends the voice call to the viewer's smartphone 106 as “Which way do you want to go ?” or “What should I do with this guy?”, the viewer responds to the voice call by “I think it's better to go to the left” or “I don't want to let it go without doing anything” so that the story unfolds depending on a context of a storyline, such as seriousness, comical, action, and the like, after an actor moves to the left or escapes the actor.

Further, as shown by the hatching 704, the guidance trigger is also arranged in the option content, and it is possible to change the video stream from one option content to the other option content. In another embodiment, a guardian may instruct to select a safe scene by voice call or the like, such as when the guardian does not want a young person such as a child to watch the video.

Further, a similar guidance trigger is added to the mainstream contents 702 and 703 that follow thereafter, and each of the option contents 702a and 703a is associated with the actions of the viewer to enable the viewer to edit the video content.

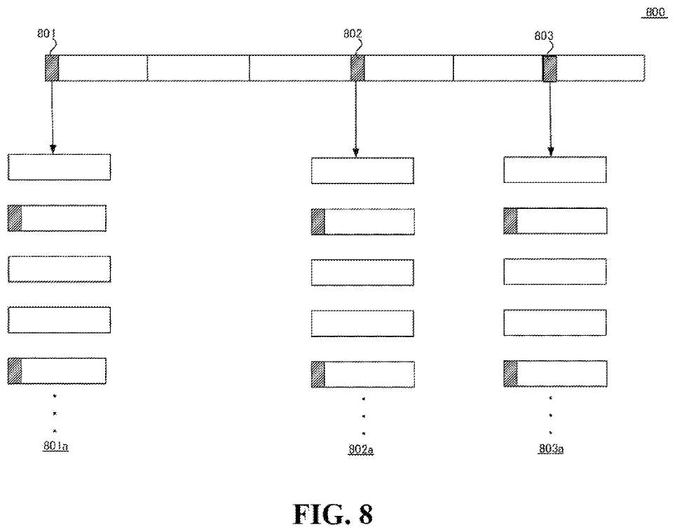

FIG. 8 is an example of an arrangement of the guidance trigger when streaming the video content in the present embodiment. The video content is distributed for each stream having a predetermined data length, and the content functioning as a guidance trigger is added to a beginning portion of the stream to be distributed. The option content is assigned to each guided trigger, and the option content corresponding to the viewer trigger is selected and can be streamed.

Note that the guidance trigger shown in FIG. 7 and FIG. 8 is preferably arranged at a beginning of the content to be reproduced or streamed. This is because a temporal buffer can be secured to avoid a delay in image reproduction associated with the processing of the content server 120, and the option content to be provided can be prepared while the guidance trigger and the viewer trigger are being processed. Note that, in the present embodiment, the position of the guidance trigger is not particularly limited as long as the option content can be provided smoothly and seamlessly, regardless of the embodiment.

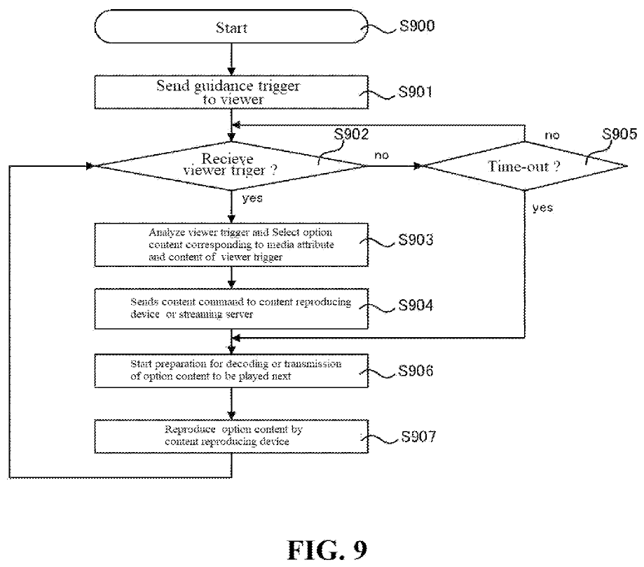

FIG. 9 is a flowchart of processing performed by the video providing system 100 of the present embodiment. The processing of FIG. 9 starts from a step S900, and when a trigger point in the mainstream content is reached in a step S901, the guidance trigger in an appropriate format is sent to the viewer. In a step S902, it is determined whether the viewer trigger included in participation information sent from the viewer exists in the trigger buffer.

In a case where there is no viewer trigger (no), it is determined whether or not there is time-out in a step S905 and in a case where there is no time-out (no), the processing is branched to the step S902 to further confirm whether or not there is the viewer trigger. On the other hand, when the time-out expires in the step S905 (yes), the trigger determines that the guidance trigger was ineffective because the viewer is sleeping, standing in the bathroom, or not aware of it at all, and then the processing is branched to a step S906, and the video continues to be provided in the sequence of the mainstream content until a timing of the next guidance trigger comes.

On the other hand, in a case where there is the viewer trigger in the step S902 (yes), the option content corresponding to the media attribute of the viewer trigger and the content of the viewer trigger is selected in a step S903, and the collaboration server 120 sends the content command to the content reproducing device 103 or the streaming server 130 in a step S904.

In the step S906, the content reproducing device 103 or the streaming server 130 selects the option content to be played next and starts preparation for decoding or transmission. Thereafter, in a step S907, the content reproducing device 103 reproduces the option content. The processing then returns to the step S902 and waits for a subsequent viewer trigger to be received.

By using the processing described above, the viewer can be guided to progress of the video, and the video can be rendered to the viewer present in the space as if the viewer were to appear with the actor in advance in movies or the like, and the sensation thereof can be shared by the viewer.

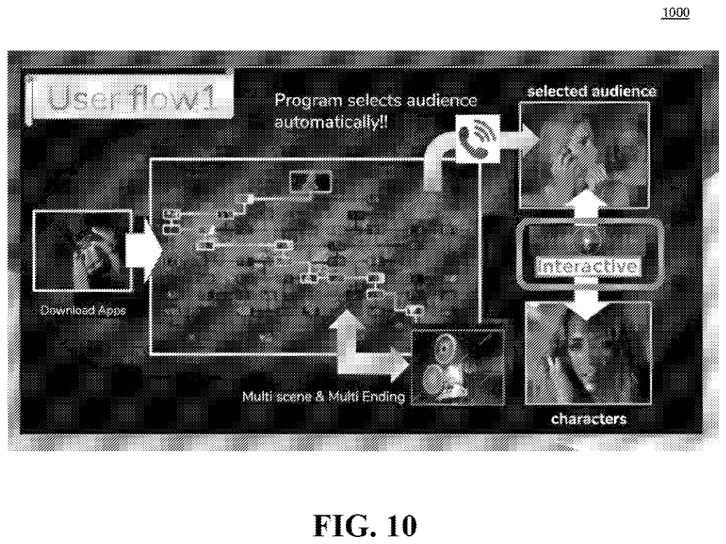

FIG. 10 is a diagram showing a data configuration of scenes 1000 used in the present embodiment. The scenes are shown with white lines that edit the scenes in cascade manner in response to the guidance triggers, and editing these scenes indicates that the content server 120 edits the sequence of the content based on the guidance trigger provided by the digital content and the transmission of the viewer trigger through the viewer's device by the guidance trigger.

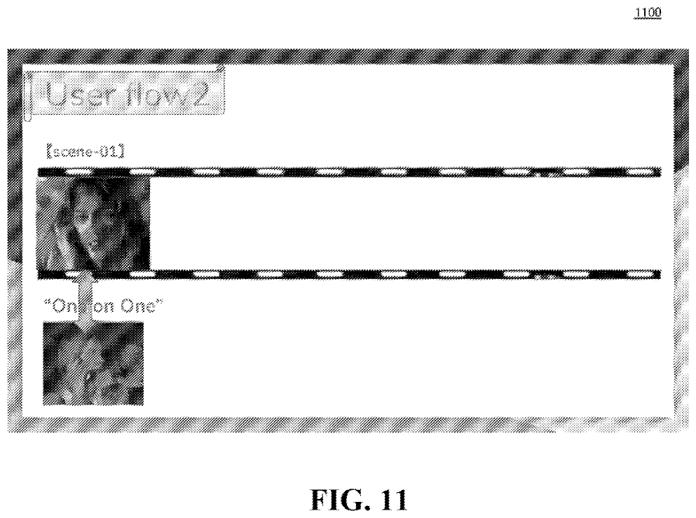

FIGS. 11-13 show streams of the digital content to be edited by the present embodiment. In a scene 01, a voice call is sent to the viewer's smartphone as a guidance trigger from an actor, character, animation character, or the like in a video. Here, the viewer refers to a preset viewer trigger in a virtual conversation with the actor. Note that, in a case where the viewer trigger cannot be obtained from the viewer, video reproducing is performed in accordance with a preset story.

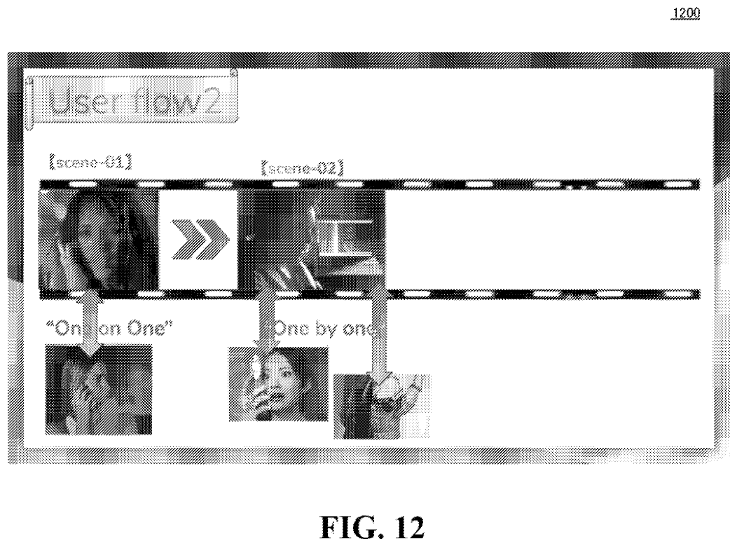

FIG. 12 is an embodiment when the viewer trigger is obtained from the viewer in FIG. 11. In FIG. 12, the modified option content corresponding to the guideway value in FIG. 11 is displayed, in which the option content sends the guidance trigger to multiple viewers in different actions. In this case, when different viewer triggers are sent from the multiple viewers, option content corresponding to the viewer trigger received earliest can be displayed. In this case, even if the same option content is displayed, psychological effects on the viewer are contradictory depending on whether behavior is contrary to the behavior instructed by the viewer or the behavior instructed by the viewer is followed, and different impressions can be provided to the viewer while providing the same content.

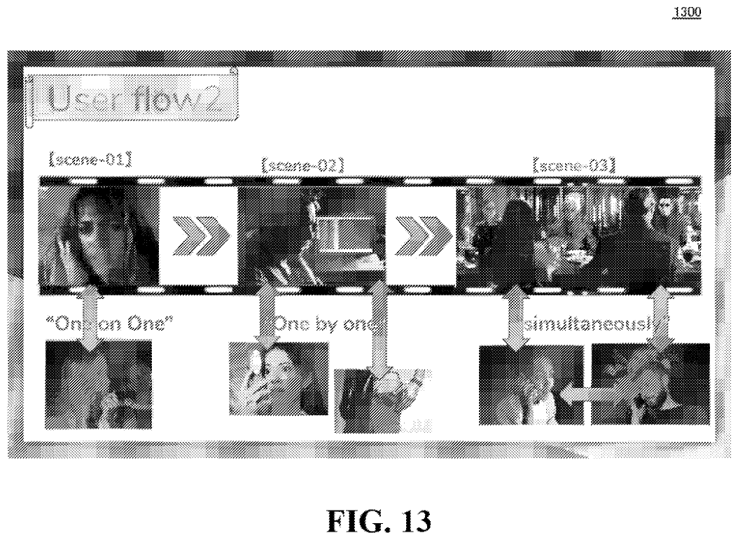

FIG. 13 shows the option content to be displayed after FIG. 12, for example, when the viewer asked for the message at SNS in FIG. 12 sends the viewer trigger and the viewer trigger is received by the collaboration server. Note that the timing of insertion of the option content is not necessarily limited to the timing immediately after FIG. 12. In the embodiment of FIG. 13, the guidance trigger may provide a group call functionality to different viewers, for example, to provide a situation as if they were talking with the actor and viewers A, B via point-to-point voice communications or point-to-group voice communications. Even in this case, as the viewer trigger, when first recognized information or explicitly requested from, for example, an actor, a character, or an animation character, the viewers A and B can edit subsequent contexts using the viewer trigger transmitted in cooperation. In this embodiment, an impression that the multiple viewers have further actively participated in the video content can be provided, and entry into the content can be made effective, such as by determining the option content by voting of the viewers.

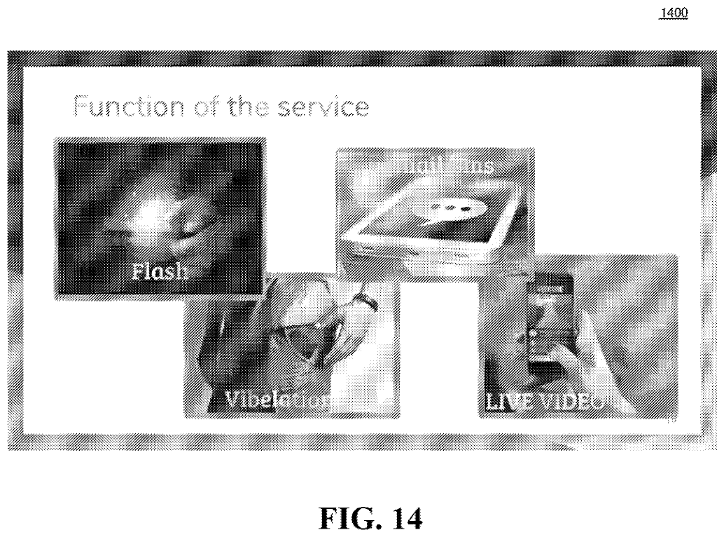

FIG. 14 shows an embodiment of the guidance trigger that may be used in the present embodiment. For example, a video transmission such as flashing of a smartphone screen, vibration, email, SNS, or a video viewed from another field of view of the content currently being provided, or panning can be used as the guidance trigger, and even in the case of video transmission, the viewer trigger can be sent by an action such as voice, tapping, swiping, or the like.

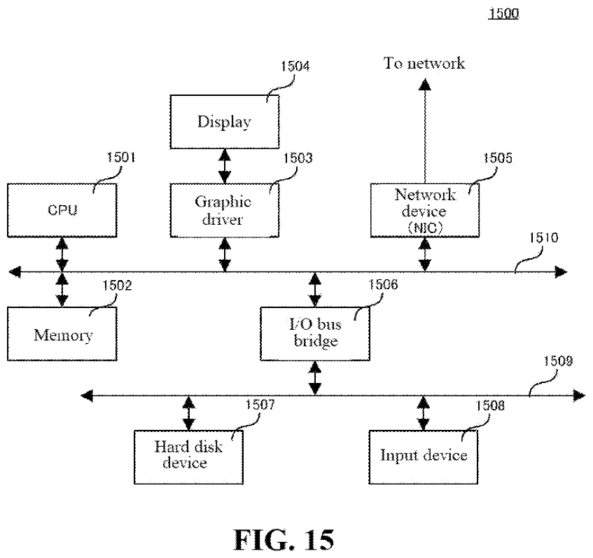

FIG. 15 is a diagram showing a hardware configuration of the content reproducing device 103 of the present embodiment. The content reproducing device 1500 of the present invention includes a central processing unit (CPU) 1501 and a memory 1002 formed from solid-state memory elements such as RAM and DRAM that enable CPU1501 processing. The CPU 1501 and the memory 1502 are connected via a system bus 1510 to other devices or drivers of the content reproducing device 103, such as a graphic driver 1503 and a network device (NIC) 1505. The graphic driver 1503 is connected to the display device 102 via an appropriate bus to display a result of the processing performed by the CPU 1501 on the display screen.

Further, the network device 1505 connects the content reproducing device 103 to a wireless network such as 4G or 5G/a network such as the Internet at the transport layer level and the physical layer level to establish a session with the user terminal.

An I/O bus bridge 1506 is further connected to the system bus 1510. A storage device 1507 such as a hard disk is connected to the downstream side of the I/O bus bridge 1506 via an I/O bus 1509 such as PCI by an IDE, ATA, ATAPI, serial ATA, SCSI, USB, or the like. Further, an input device 1508 such as a pointing device such as a keyboard and a mouse is connected to the I/O bus 1509 via a bus such as USB and receives inputs and commands from an operator such as a system administrator.

More specifically, examples of the CPU 1501 used by the content reproducing device 103 include PENTIUM (registered trademark) to PENTIUM IV (registered trademark), PENTIUM (registered trademark) compatible CPU, CORE2DUO (registered trademark), COREi3 to i7 (registered trademark), POWER PC (registered trademark), XEON (registered trademark), and the like.

Examples of an operating system (OS) to be used include MacOS (registered trademark), Windows (registered trademark), UNIX (registered trademark), LINUX (registered trademark), CHROME (registered trademark), ANDROID (registered trademark), and other suitable OS. Further, the content reproducing device 103 stores and performs application programs running on the OS described above and described in programming languages such as C, C++, Visual C++, VisualBasic, Java (registered trademark), Java (registered trademark) ScriptPerl, and Ruby.

Further, although functional configurations of the collaboration server 120 and the streaming server 130 used in the present embodiment differ depending on a provision function, the same hardware configuration can be adopted.

Note that the program of the present embodiment is referred to as a so-called “application” and can be performed by downloading the program to the viewer device, such as the smart speaker 104, the tablet terminal 105, and the smartphone 106. Furthermore, a content viewing device 104 can also be implemented by using a program or the like that uses an executable just-in-time compiler or the like without compiling or resetting the program by downloading it through the network.

Basic elements of the device used by the viewer of the present embodiment is not significantly different from the configuration of the content reproducing device 103 shown in FIG. 15 except that the device includes a function of connecting to a public telephone line. For example, Snapdragon (registered trademark), Helio (registered trademark), Tegra (registered trademark), Apple A Series (registered trademark), Exynos (registered trademark), Kirin (registered trademark), or the like for smartphones can be used as CPU. Furthermore, as the storage device 1507 such as a hard disk device, for example, a NAND-gate type rewritable flash memory, an SSD, or the like can be used.

In addition, examples of the OS performed by the device required by the viewer include Android (registered trademark), iOS (registered trademark), Bada (registered trademark), BlackBerry OS (registered trademark), Fire Fox (registered trademark), Symbian OS (registered trademark), BREW (registered trademark), WindowsMobile (registered trademark), WindowsPhone (registered trademark), but are not limited thereto.

### Second Embodiment

A second embodiment will be described below. A second embodiment is a video providing system that edits and provides the content in accordance with viewers or audience behavior in theaters, live performances, and the like.

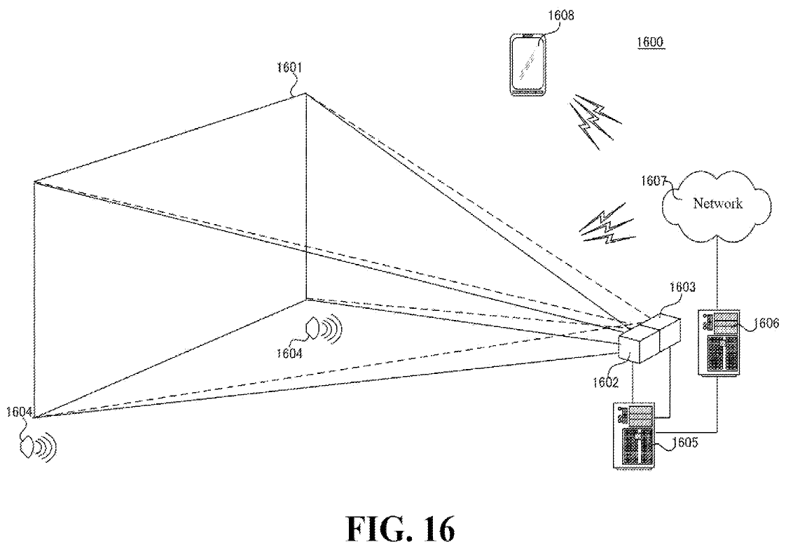

Hereinafter, the present invention will be described with reference to embodiments, but the present invention is not limited to the embodiments described later. FIG. 16 shows an embodiment of the video providing system 1600 of the first embodiment of the present embodiment. A video providing system 1600 shown in FIG. 16 can be installed in a space for viewing by a large number of viewers, such as a theater, a cinema complex, and event venue. The video providing system 1600 projects video onto the screen 1601 from the projectors 1602 and 1603 onto the screen 1601, and projects the video onto the screen 1601 to enable viewing by the large number of viewers.

A speaker 1604 is installed in a vicinity of the screen 1601, and sends sound synchronized with the video projected from the projectors 1602 and 1603 into the space. Note that the speakers 1604 shown in FIG. 1 are not limited to two speakers and may be appropriately installed in accordance with the size of the space and differences in sound sources to be provided, such as four speakers 1604, six speakers 1604, and eight speakers 1604 on the left and right as necessary. For example, two speakers may be used to generate encoded sounds synchronously with the content projected from the projectors 1602, 1603, while the other two speakers may be used to reproduce audio data received by the IVR in real time to enable the viewer participation described below.

Further, although the embodiment shown in FIG. 16 is described as using two projectors as the projectors 1602 and 1603 for the purpose of explanation, it is not necessary to use two projectors as long as the projectors have a configuration in which independent video can be dually projected, and more projectors can be used. The projectors 1602 and 1603 are used, for example, to change the video in accordance with information sent by the viewer by performing projection mapping on the video from the proj ector 1602.

The video providing system 1600 is further configured to include a content server 1605 and a collaboration server 1606. The content server 1605 has a function of controlling the content to be projected by the projectors 1602 and 1603 and a decoding sequence of the content. The collaboration server 1606 also includes functions of a web server and a voice processing (IVR) server. The collaboration server 1606 processes the user information, the viewer participation information, the voice information, and the like sent by the viewers from a mobile terminal 1608 such as a mobile phone, a smartphone, or a tablet terminal from the viewers sharing the video in the space through a network or a public telephone network 1607. Note that, in addition to communication using a TCP/IP protocol using gigabit Ethernet (registered trademark), the network 1607 will be described below as including data communication using a wireless communication protocol such as 4G and 5G, and/or both of voice communication using the public telephone network and the data communication. In addition, the application for communication can be used by a person capable of so-called SNS data communication, such as Facetime (registered trademark), LINE (registered trademark), Facetime (registered trademark), and Twitter (registered trademark).

The collaboration server 1606 has a function of modifying a video decoding order of the content server 1605 in response to a response from the viewer, causing the speaker 1604 to generate additional audio information, and the like. Note that although

FIG. 16 shows a configuration in which the content server 1605 and the collaboration server 1606 are separated from each other, the second embodiment of the present invention is described as a separate server for the purpose of clarifying the functional configuration, and as long as the capability of the information processing device is sufficient, a plurality of functions can be installed on a single server device without a separate configuration.

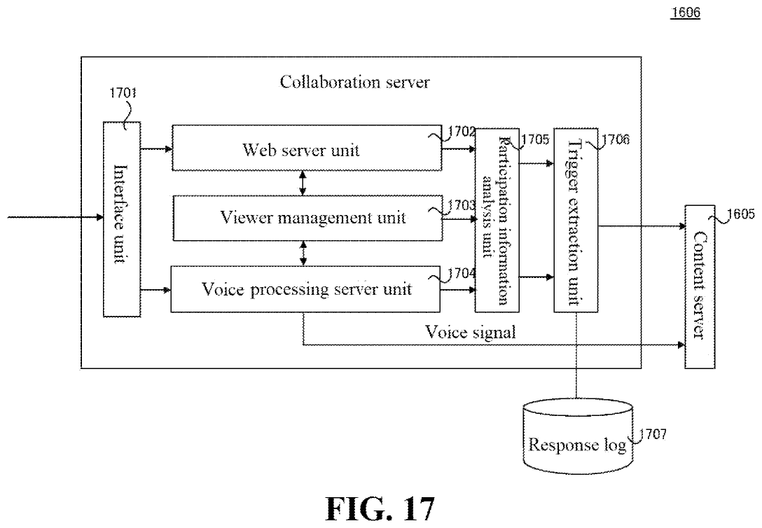

FIG. 17 is a diagram showing a functional block of the collaboration server 1606 of the second embodiment. As shown in FIG. 17, the collaboration server 1606 is configured to include an interface unit 1701, a web server unit 1702, and a voice processing server unit 1704. The web server unit 1702 has a function of receiving the user information sent by the viewer through the network 1607 via the HTTP protocol or the viewer participation information sent through a dedicated application (hereinafter, simply referred to as a smartphone application) that functions on the smartphone 106, or the like and registering the user information, the terminal form used, the participation mode, the action, and other information in a viewer management unit 1703. The viewer participation information includes the viewer trigger that the viewer can configure as keywords, commands, or the like for modifying content, and in the case of a voice call, the viewer participation information includes voice call information of the viewer.

The voice processing server unit 1704 includes a so-called IVR function. When the viewer participation information is voice information, the voice processing server unit 1704 sends the voice information to a participation information analysis unit 1705 as the participation information. Also, in a specific embodiment, the voice information of the received voice call may be sent to the content server 1605 as it is and generated from speaker 1604 and may be superimposed on voice information of the decoded digital content so that the viewer present in the space feeds back the voice call as if the participant who sent the voice call was in the content from the beginning.

A viewer management unit 1703 has a function to collect information such as a user ID of the viewer and, as necessary, a password, a terminal form, and a participation mode sent through the network 1607 in advance and register the information in a user database (not illustrated). In addition, the web server unit 1702 and the voice processing server unit 1704 each have a function of causing the participation information analysis unit 1705 to perform processing corresponding to the participation mode of the viewer when receiving the participation information.

Further, the collaboration server 1606 is configured to include the participation information analysis unit 1705 that analyzes the viewer participation information sent from the viewer and a trigger extraction unit 1706. The participation information analysis unit 1705 determines whether the participation information transmitted from the viewer is voice information or a command from the application or the like, decodes the participation information of the viewer in accordance with the participation form of the viewer, and determines whether or not the viewer participation information including a preset viewer trigger is included in the trigger extraction unit 1706 according to a mode of viewer participation.

When the viewer trigger is not included, no particular command is issued to content server 1605. Further, in a case where it is determined that the preset viewer trigger is included in the viewer participation information, a command is sent to the content server 1605 to enable the viewer to participate in the video and audio by switching the decoding order of the digital content decoded by the content server 1605, or by separating the video and audio parts of the digital content and decoding only the video part to replace that part with other audio information, or by performing the projection mapping, or superimposing it on other audio information. Note that voice processing function can be configured as a cloud server, and a service including, for example, AI such as Google Assistant (trademark) and IBM Speech to Text (registered trademark) can be used as the cloud service for performing such voice processing but is not limited to a specific cloud service.

Further, the collaboration server 1606 manages a response log database 1707. The response log database 128 registers history of viewer participation in not only the screening of that time, but also the same video or event that was performed in the past by associating the history of viewer participation with the user information, a user attribute, screen time, screened area, and the like. Examples of the state of viewer participation include scene selection, voice information type, command type from the smartphone application, and the like, and the collaboration server 1606 accumulates these as a response log.

In the second embodiment, collaboration server 1606 may analyze the response log, select a scene or video in which many participants sympathize with in the screen or event and learn the content to cause the content server 1605 to display it. Further, response information accumulated in the response log database 1707 may be used as big data for subsequent content creation.

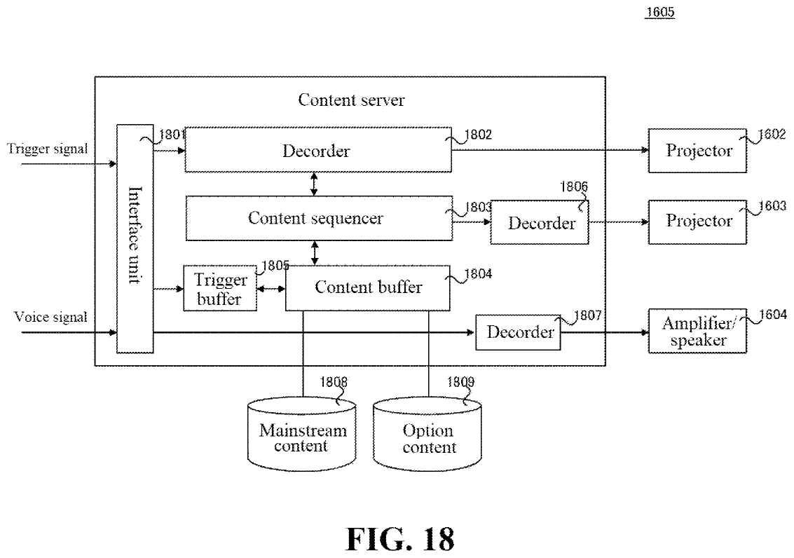

FIG. 18 shows a functional block of the content server 1605 of the second embodiment. The content server 1605 receives the viewer trigger and, if present, an audio signal received by the IVR from the collaboration server 1606. The content server 1605 includes an interface unit 1801 for processing these signals, a decoder 1802, a content sequencer 1803 and a trigger buffer 1805.

Hereinafter, the function will be described from the processing unit on the upstream side that has received the participation information from the viewer. The trigger buffer 1805 has a function of buffering the viewer trigger included in the participation information. Note that the scene means a time-series video provided with a certain meaning or attribute in the mainstream content, which is composed of a plurality of scenes, a plurality of GOPs (Group of Picture), and the like.

The content server 1605 includes a function to cause the options database 1809 to load, in advance, the content for providing video enabling viewer participation to be decoded as a next scene in response to the viewer trigger in the viewer participation information. The content server 1605 loads the mainstream content for providing the video from a content database 1808 and stores it in a content buffer 1804. The mainstream content stored in the content buffer 1804 is sent to the decoder 1802 in response to a command from the content sequencer 1803 to enable projection from the proj ector 1602.

Further, the content server 1605 determines the viewer trigger in the trigger buffer 1805, causes the content buffer 1804 to load the content for providing subsequent video to provide an option to the viewer and modifies a reproduction order table in which a scene order for the content sequencer 1803 to load is registered according to the viewer trigger. Further, as necessary, the content buffer 1804 separates video portion information and audio information portion of the scene being loaded and modifies the content of the scene so as to reproduce only the video portion or the audio portion.

To provide this function, the content server 1605 uses a lookup table or the like to determine an identification value specifying the option content specified by the viewer trigger content and the corresponding guidance trigger content. After that, the option content specified by the identification value is loaded into the content buffer using the determined identification value.

The content sequencer 1803 refers a reproduction order table and supplies the scene or the content to the decoder 1802 in ascending order of the reproduction order to start decoding. The decoder 1802 decodes the sent scene sequence using an appropriate decoding scheme for H264, MPEG4, and other high vision, 4K, 8K, and 3D, and supplies a video image to the projector 1602 via an appropriate video driver such as VGA, SVGA, and XGA.

Further, the content server 1605 corresponds to the viewer trigger. When the viewer trigger commands projection mapping, for example, the content server 1605 loads the content for projection mapping in synchronization with the reproduction of the corresponding scene in the reproduction order table of the scene for performing projection mapping and sends the content for the projection mapping to the decoder 1806 to enable synchronized projection mapping from the projector 1603.

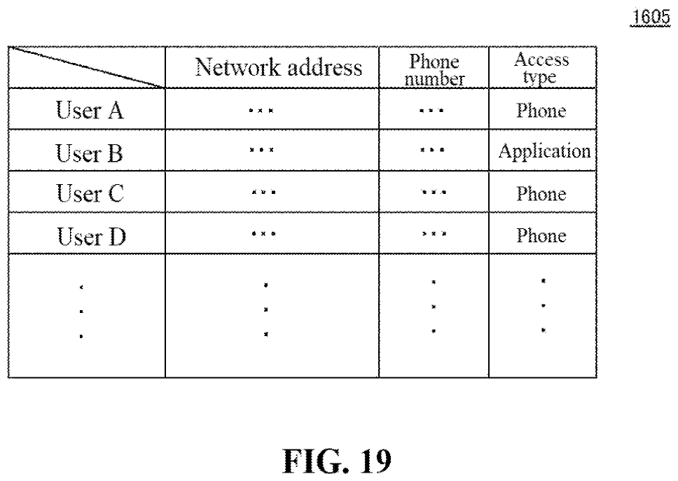

FIG. 19 shows an embodiment of a user database created by the viewer management unit 1703 described in FIG. 17. The user information uniquely identifying the user, network information of the user, a phone number, an access type, and the like are registered in the user database, and reaction information registering how the user has reacted to the guidance trigger provided by the contents can be registered in association with each other as necessary.

The collaboration server 1606 first receives a registration of the user information or the like from the viewer and registers the user information and the like in the user database shown in FIG. 19. Thereafter, when a trigger timing embedded in advance in the mainstream content arrives, the viewer to be participated is randomly determined or the viewer to be participated is determined by using attribute information preset for the trigger. The collaboration server 1606 then sends the information set as the trigger to the determined viewer.

The viewer is guided by the trigger information and sends the participation information to the collaboration server 1606 from a GUI such as a button of the smartphone application and the scroll bar. In another embodiment, the viewer receives a call by the IVR function of the collaboration server 1606 and sends a voice call to the collaboration server 1606, whereby the participation information from the viewer can be sent.

The collaboration server 1606 receives the participation information from the viewer and performs the above-described processing to enable the viewer participation in the form of audio/video, both audio and video, video, projection mapping, and the like.

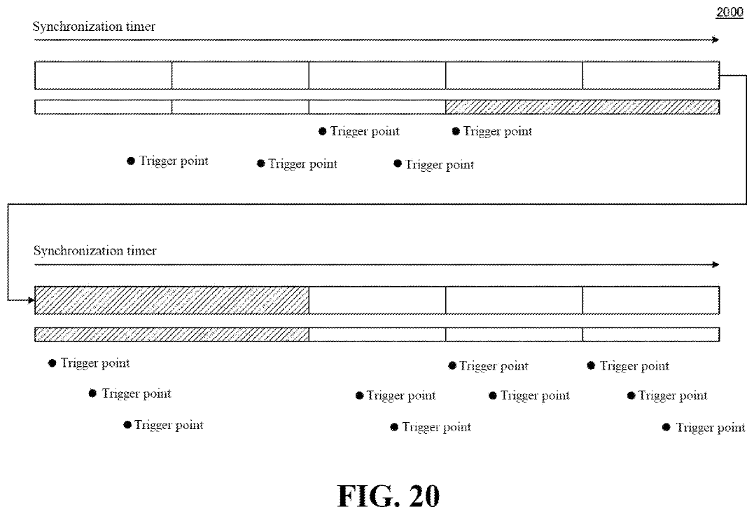

FIG. 20 shows an embodiment of a trigger registration form and information to be used as a scene to be decoded in the mainstream content 2000 of the second embodiment. The mainstream content is composed of a plurality of scene sequences, header information or meta information is added to each scene, and scene order, trigger attributes, times, corresponding option content identification values, and the like are registered in the scene sequence. A specific time position of the scene is set to be a trigger point, and different option content can be called up depending on the position of the set trigger point.

Further, a single trigger point or multiple trigger points can be configured for the scene, and the option content to be called can be changed depending on the time position indicating whether or not the viewer responds. Furthermore, in the second embodiment, it is possible to configure whether both video and audio portions are decoded, only the video portion is decoded, or only the audio portion is decoded when decoding is performed. In the case of this embodiment, modes of the viewer participation can be further diversified, such as providing completely different videos or providing completely different audio information even with the same video, in accordance with the participation information of the viewers.

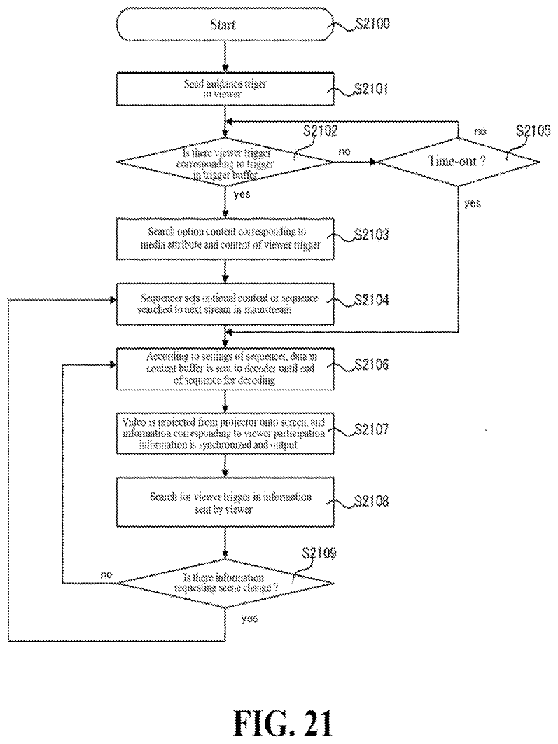

FIG. 21 is a flowchart of processing performed by the video providing system 1600 of the second embodiment. The processing of FIG. 21 starts from a step S2100, and when a trigger point in the mainstream content is reached in a step S2101, the guidance trigger in an appropriate format is sent to the viewer. In a step S2102, it is determined whether the viewer trigger included in participation information sent from the viewer exists in the trigger buffer.

In a case where there is no viewer trigger (no), it is determined whether or not there is time-out in a step S2105 and in a case where there is no time-out (no), the processing is branched to the step S2102 to further confirm whether or not there is the viewer trigger. On the other hand, when the time-out expires in the step S2105 (yes), the trigger determines that the guidance trigger was ineffective because the viewer is sleeping, standing in the bathroom, or not aware of it at all, and then the processing is branched to a step S2106, and the video continues to be provided in the sequence of the mainstream content until a timing of the next guidance trigger comes.

On the other hand, in a case where there is the viewer trigger in the step S2102 (yes), the option content corresponding to the media attribute and the content of the viewer trigger is searched from an option database 1809 in a step S2103 and loaded into the content buffer 1804, and in a step S2104, the content server 1605 modifies the reproduction order in the reproduction order table to set the reproduction sequence. Thereafter, in the step S2106, the content sequencer 1803 loads the scene to be reproduced next, sends it to the decoder 1802, decodes it in the specified order, and sends a video signal to the projector in a step S2107 to enable video reproduction. Note that, at this time, by providing the video superimposed on the video projected as voice information or video information to the viewer in accordance with the viewer participation information, the participation of a single viewer can be shared by all the viewers present in the space.

In a step S2108, the viewer trigger such as other keywords or commands is searched in the viewer participation information, and in a step S2109, it is determined whether or not there is information requesting a scene change as the viewer trigger.

When there is such information (yes), the processing is branched to the step S2104 to change the sequence and enable the viewer participation. On the other hand, in a case where there is no information in the step S2109, the processing is branched to the step S2106 to continue decoding the video without changing the scene.

By using the processing described above, the viewer can be guided to progress of the video, and the video can be rendered to the viewer present in the space as if the viewer were to appear in movies or the like in advance, and the sensation thereof can be shared by all the viewers.

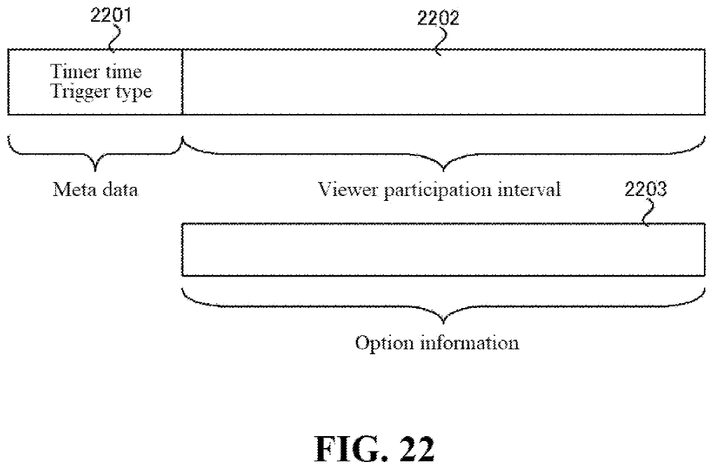

FIG. 22 is a diagram showing a data configuration of a scene used in the second embodiment. The scene can be configured to include header information 2201 and a scene content 2202 defined as a plurality of frame sequences. A timer time, a trigger type, a scene number, and the like of the trigger point can be set as the meta information in the header information 2201. A time length of the scene defined by scene content 2202 defines the viewer participation interval. Synchronously superimposing the option content in a mode such as audio, video, or the like during the time length enables scene changes, audio changes, video modulation by projection mapping, or the like.

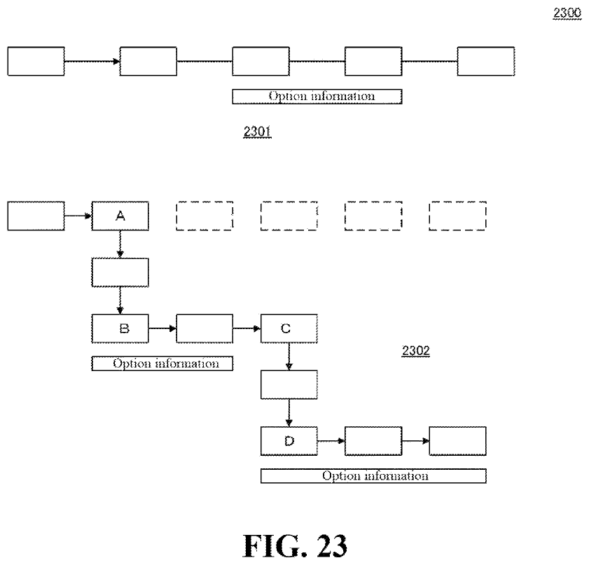

FIG. 23 shows an embodiment of video content 2300 provided by the video providing system 1600 of the second embodiment. Video content 2301 is an embodiment that enables viewer participation by changing the audio as optional information or performing projection mapping without changing the scene sequence of the mainstream content 2300, and for example, can be used to provide the content such as video, music, or the like in a specific event, concert site, or the like.

Further, video content 2302 is an embodiment in which the sequence of the mainstream content 2300 is replaced by the viewer participation. Upon receiving the viewer participation information at scene A, the content server 1605 modifies the next scene and modifies the mainstream content. When the other viewer participation information is received in scene B, the next scene is changed to provide the video. Further, in scene C, the other viewer participation information is received to modify the sequence of the scene, and further, in scene D, the sequence of the scene is modified corresponding to the viewer participation information, and this is continued until the end of the video.

Note that the viewers who can send the viewer participation information to the scene A to D may be the same or different. The option information may be voice information or video information such as projection mapping. In yet other embodiments, projection mapping may be used to display digital content, the mainstream content may be projection-mapped to the option content and displayed, or vice versa.

The above functions of the present embodiment can be realized by a device executable program written in object-oriented programming languages such as C++, Java (registered trademark), Java (registered trademark) Beans, Java (registered trademark) Applet, Java (registered trademark) Script, Perl, Ruby, and Python, for example, a program referred to as an application, and can be downloaded through the network or recorded and distributed on a device-readable recording medium. Further, the elements common to the first embodiment and the second embodiment may be shared or may include a plurality of types of collaboration servers in a specific application.

As described above, according to the present invention, it is possible to provide a video providing system and a program configured to control progress of content in a manner of involving a viewer who views a video reflected on a display device.

The present invention has been described above with reference to embodiments, but the present invention is not limited to the embodiments shown in the drawings and can be modified within the scope that can be conceived by a person skilled in the art, such as other embodiments, additions, changes, and deletions, and all aspects are within the scope of the present invention as long as the effects of the present invention are achieved.

What is claimed is:

1. A video providing system for providing digital content to a viewer, the system comprising:
a component for receiving a guidance trigger prompting the viewer to participate in video content at a device of the viewer;
a component for accepting an option content command or option content that is different from mainstream content corresponding to a viewer trigger sent from the device as a response to the guidance trigger through a network; and
a component for reproducing or displaying the option content on a display device.

2. The video providing system as claimed in claim 1, wherein the guidance trigger is provided to the device through a function of the device including voice, vibration, email and SNS.

3. The video providing system as claimed in claim 1, wherein reproduction of the option content is performed through a media medium and display of the option content displays the option content acquired through the network on the display device, a video screen, or an object.

4. The video providing system as claimed in claim 1, wherein reproduction of the option content is performed by video streaming.

5. The video providing system as claimed in claim 1, wherein display of the option content is performed by the video screen or projection mapping.

6. The video providing system as claimed in claim 1, comprising a collaboration server for communicating between a plurality of viewers.

7. The video providing system as claimed in claim 6, wherein the collaboration server performs collaboration by voice communication using SNS.

8. The video providing system as claimed in claim 1, wherein the option content is determined by voting of a large number of the viewers.

9. An executable program for making an information processing device function as a video providing system that provides digital content to viewer, the information processing device being made to function as:
a component for receiving a guidance trigger prompting the viewer to participate in video content at a device of the viewer;
a component for accepting an option content command or option content that is different from mainstream content corresponding to a viewer trigger sent from the device as a response to the guidance trigger through a network; and
a component for reproducing or displaying the option content on a display device

10. The program as claimed in claim 9, wherein the guidance trigger is provided to the device through a function of the device including voice, vibration, email and SNS.

11. The program as claimed in claim 9, wherein reproduction of the option content is performed through a media medium and display of the option content displays the option content acquired through the network on the display device, a video screen, or an object.

12. The program as claimed in claim 9, wherein reproduction of the option content is performed by video streaming.

13. The program as claimed in claim 9, wherein display of the option content is performed by the video screen or projection mapping.

14. The program as claimed in claim 9, comprising a collaboration server for communicating between a plurality of viewers.

15. The program as claimed in claim 14, wherein the collaboration server performs collaboration by voice communication using SNS.

16. The program as claimed in claim 1, wherein the option content is determined by voting of a large number of the viewers.
